(19) United States
(12) Patent Application Publication
(10) Pub. No.: US 2016/0127786 A1
(43) Pub. Date: May 5, 2016

(54) APPARATUS, SYSTEMS AND METHODS FOR MEDIA DEVICE SECURITY

(71) Applicant: EchoStar Technologies L.L.C., Englewood, CO (US)

(72) Inventor: Paul Langer, Westminster, CO (US)

(73) Assignee: EchoStar Technologies L.L.C., Englewood, CO (US)

(21) Appl. No.: 14/530,471

(22) Filed: Oct. 31, 2014

(51) Int. Cl. H04N 21/475; H04N 21/45; H04N 7/16; H04N 21/454; H04N 21/4627; H04N 21/4147; H04N 21/478; H04N 21/658; H04N 21/41; H04M 11/00; H04N 21/414

(52) U.S. Cl. CPC H04N 21/4751; H04M 11/007; H04N 21/4532; H04N 7/163; H04N 21/4542; H04N 21/41407; H04N 21/4147; H04N 21/4781; H04N 21/6581; H04N 21/4108; H04N 21/4627

(57) ABSTRACT

Media device systems and methods are operable to provide security against unauthorized access to content or unauthorized control of the media device. An exemplary embodiment detects a wireless signal, with an identifier, that is emitted by at least one mobile electronic device that is currently in possession of a user, determines the identifier of the at least one mobile electronic device, retrieves a plurality of stored mobile device identifiers that identify each one of a plurality of mobile electronic devices, compares the identifier of the at least one mobile electronic device with the plurality of stored mobile device identifiers, and then permits access to restricted content or permits the media device to perform a restricted function only when the identifier of the at least one mobile electronic device matches one of the plurality of stored mobile device identifiers.

### BACKGROUND

Media devices, such as a set top box, a stereo, a television, a computer system, a game system, or the like, are often configured to receive operating instructions from a user after a password and/or other suitable user identity verification has been provided by the user to ensure that the user is authorized to use the media device. For example, a password and/or other suitable user identifier may be used to authorize use of the media device. In the absence of the user identifier, access by unauthorized users who may be using the media device is limited and/or is prevented.

For example, access at the media device may be limited to and/or denied for certain types of content (such as PG, R, and or X rated movies, adult content, or particularly violent content), for pay per view content, for purchases of content or physical products, and/or games. Access may be limited on time basis such as a minor is allowed access for a two hour period per day once authorized, for example. Such access limitations may be selectably defined and enforced in situations where there are minors or children who might inadvertently, or intentionally, access the otherwise restricted content.

The password and/or other suitable user identity verification is typically entered manually by the user. However, the password and/or other suitable user identity verification may be difficult to remember because some minimum level of complexity is necessarily required of the password to ensure security. In other situations, it may be undesirable to use some types of user identity verification, such as account numbers, social security numbers, or other types of personal information. In yet other situations, unauthorized users may covertly obtain the password or user verification.

Accordingly, there is a need in the arts to provide enhanced security access in media devices.

### SUMMARY

Systems and methods of media device security are disclosed. An exemplary embodiment detects a wireless signal, with an identifier, that is emitted by at least one mobile electronic device that is currently in possession of a user, determines the identifier of the at least one mobile electronic device, retrieves a plurality of stored mobile device identifiers that identify each one of a plurality of mobile electronic devices, compares the identifier of the at least one mobile electronic device with the plurality of stored mobile device identifiers, and then permits access to restricted content or permits the media device to perform a restricted function only when the identifier of the at least one mobile electronic device matches one of the plurality of stored mobile device identifiers.

### BRIEF DESCRIPTION OF THE DRAWINGS

Preferred and alternative embodiments are described in detail below with reference to the following drawings:

FIG. 1 is a block diagram of an embodiment of a media device security system implemented in a media device; and

FIG. 2 illustrates an example security GUI that may be displayed to the user be embodiments of the media device security system.

### DETAILED DESCRIPTION

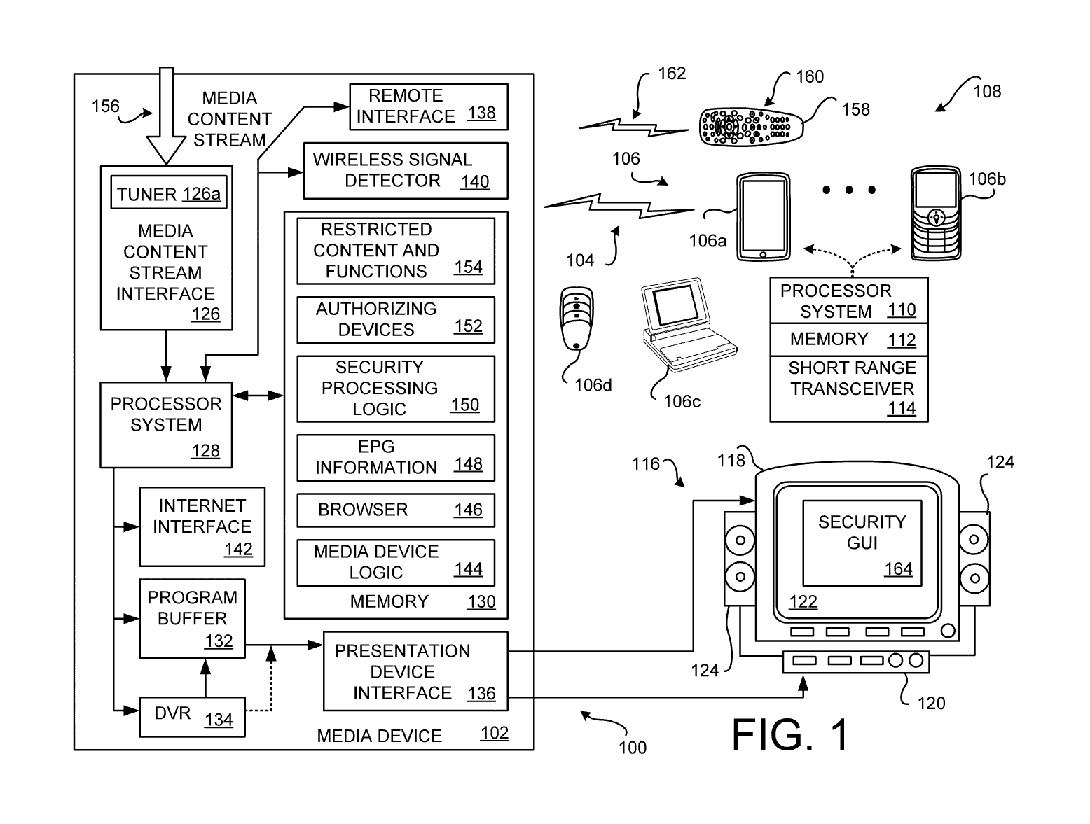

FIG. 1 is a block diagram of an embodiment of a media device security system 100 implemented in a media device 102, such as, but not limited to, a set top box (STB). Embodiments of the media device security system 100 may be implemented in other media devices, such as, but not limited to, a stereo, a surround-sound receiver, a radio, a television (TV), a digital video disc (DVD) player, a digital video recorder (DVR), a game playing device, or a personal computer (PC) that is configured to receive communications from a remote control.

Embodiments of the media device security system 100 are configured to permit the media device 102 to access to otherwise restricted content and/or to permit the media device 102 to perform otherwise restricted functions. User authorization is determined when the media device 102 receives a wireless signal 104 from one or more of a plurality of mobile electronic devices 106. Such mobile electronic devices 106 are typically kept in the current personal possession of the authorized user.

The mobile electronic devices 106 are configured to communicate the wireless signals 104 to control operation of another electronic-based device (not shown). The other electronic-based device performs functions that are unrelated to control or operation of the media device 102 and/or components of a media presentation system 116.

The wireless signal 104 emitted from a mobile electronic device 106 tends to indicate that the authorized user (presumably in possession of the authorizing mobile electronic device 106) is at least present in the vicinity of the media device 102. In the absence of the wireless signal 104 (which presumably indicates that the user is no longer in the vicinity of the media device 102), the media device 102 is not able to access otherwise restricted content and/or is not able to perform otherwise restricted functions.

In the various embodiments, each one of the authorized mobile electronic devices 106 are known to be owned by, or at least in possession of, an authorized user (or a plurality of authorized users). Accordingly, if the authorized user is in proximity to (in the vicinity of) the media device 102 while in possession of the authorizing mobile electronic device 106, access is authorized in response to the media device 102 detecting the wireless signal 104 emitted by the authorizing mobile electronic device 106.

Here, possession of the authorized mobile electronic device 106 by an authorized user means that the mobile electronic device 106 is currently in the possession of the user (such as, but not limited to on the authorized user's body, is being held by the authorized user, is in the authorized user's clothes, and/or is in the immediate vicinity of the user within some predefined threshold distance, such as twenty feet). Accordingly, if the user leaves the operating environment 108 where the media device is located, it is expected that the user will remain in possession of the mobile electronic device 106 and will be taking their mobile electronic device 106 with them when they leave. Therefore, it is unlikely that an unauthorized user will have possession of the mobile electronic device 106 (thereby thwarting the use of the media device 102 by the unauthorized user, at least when the authorized user and their authorizing mobile electronic device 106 are not concurrently present with the unauthorized user in the operating environment 108). When the authorized user leaves the vicinity of the media device 102, the wireless signal 104 emitted by the mobile electronic device 106 is no longer detectable, and restrictions are then enforced at the media device 102.

The operating environment 108 is defined as a space of limited dimensions and/or size where a user is able to view and/or listen to media content presented by the media device 102. Examples of an operating environment 108 include a media room, a vehicle, or other region of space. The region of space of the operating environment 108 may be enclosed, such as within a room, vehicle, or other enclosure. Or, the operating environment 108 may be an outside region (outdoors in the environment).

In the various embodiments, the mobile electronic device 106 emitting a wireless signal 104 must be in close proximity to the media device 102 for the wireless signal 104 to be detected. In the various embodiments, the wireless signal 104 has a limited range and/or strength. Therefore, the wireless signal 104 is not detectable by the media device 102 when the mobile electronic device 106 is outside of the operating environment 108. Accordingly, the requisite close proximity of the mobile electronic device 106 to the media device 102 corresponds to an assumption that the authorized user is present within the operating environment 108, and that the use of the media device 102 is therefore authorized.

Example authorizing mobile electronic devices 106 include a processor system 110, a memory 112, and a short range transceiver 114. The processor system 110 is operable to generate the wireless signal 104 that includes a suitable unique identifier of the mobile electronic device 106 that has been stored in the memory 112. Any suitable authorizing mobile electronic device 106 may be used, such as the example note pad 106a or the example cell phone 106b (which includes other telephonic type devices such as, but not limited to, a smart phone) that are configured to communicate at least voice communications with other telephonic devices.

The wireless signal 104 emitted from the transceiver 114 is of limited range and/or strength in a preferred embodiment. Accordingly, the emitting authorizing mobile electronic device 106 includes an identifier of the mobile electronic device 106 in the emitted wireless signal 104 that is detected by the media device 102. The unique identifier of the emitting mobile electronic device 106 is used by the media device 102 to determine that the received wireless signal 104 is emitted by an authorized mobile electronic device 106. In some embodiments, the unique identifier may be encrypted or otherwise obfuscated to prevent changing by an unauthorized user, and/or by use in a different mobile electronic device by an unauthenticated user.

When the media device 102 detects the wireless signal 104, the media device 102 determines the identifier of the emitting mobile electronic device 106. When the determined identifier corresponds to a preauthorized identifier stored at the media device 102, the media device 102 determines that the emitting mobile electronic device 106 is an authorizing mobile electronic device 106. Then, access to otherwise restricted content and/or performance of otherwise restricted functions will be permitted by the media device 102.

In some embodiments, access to otherwise restricted content and/or performance of otherwise restricted functions by the media device 102 will continue to be permitted until the media device 102 no longer detects the wireless signal 104 emitted from the authorizing mobile electronic device 106. Accordingly, embodiments of the media device security system 100 continuously monitor, or periodically monitor, the operating environment 108 for the presence of the wireless signal 104. When the wireless signal 104 with the identifier of the authorizing mobile electronic device 106 is no longer detected by the media device 102, the media device security system 100 then determines that the authorized user is no longer present in the operating environment 108 (and presumably, is no longer using the media device 102). Accordingly, the media device 102 then prohibits access to otherwise restricted content and/or performance of otherwise restricted functions.

In some embodiments, the wireless signal 104 may be absent (not detected) for a predefined duration. For example, the predefined duration may be set at fifteen minutes. Accordingly, the authorized user is able to leave the location of the media device 102 for at least fifteen minutes. Thus, when the authorized user returns within the predefined duration, presentation and/or storage of media content has not yet been interrupted.

For example, if the authorized user is present in the operating environment 108 (as indicated by the media device 102 detecting the wireless signal 104 emitted by the user's authorizing mobile electronic device 106), the media device 102 is operable to present otherwise restricted content, such as adult content, mature content games, and/or pay-for-view content. As another example, if the authorized user is present in the operating environment, the media device 102 is operable to permit otherwise restricted functions, such as purchasing pay-for-view media content and/or purchasing other goods or services using the media device 102.

In an example embodiment, if the authorized user leaves the operating environment (presumably taking their authorizing mobile electronic device 106 with them), the media device 102 may, in some situations, immediately restrict further access to restricted content and/or limit performance of otherwise restricted functions. For example, presentation of the restricted content may be ended or otherwise ceased when the authorized user leaves the operating environment 108. Alternatively, or additionally, purchasing pay-for-view media content and/or purchasing other goods or services using the media device 102 may be immediately halted. In the various embodiments, the media device 102 may be configured by the user to operate in the above described manner wherein access to otherwise restricted content and/or performance of otherwise restricted functions is immediately enforced.

In another situation, presentation of the previously authorized restricted content is allowed to proceed until its conclusion, or until viewing is ended. However, access is not permitted to any new restricted content (since the user and their authorizing mobile electronic device 106 are not present in the operating environment 108). For example, a different user (presumably an unauthorized user) cannot change channels to receive different restricted content. As another example, the different user is not permitted to purchase new pay-for-view content, goods, and/or services using the media device 102 (even though they may be allowed to finish viewing previously paid for content). In the various embodiments, the media device 102 may be configured by the user to operate in the above described manner.

In an example embodiment, the wireless signal 104 is a Bluetooth communication signal. The Bluetooth communication signal is well known to employ a short range wireless technology standard for exchanging data over short distances using short-wavelength ultra high frequency (UHF) radio waves in the industrial, scientific and medical (ISM) radio band from 2.4 to 2.485 GHz. Bluetooth technology may be used by fixed and mobile devices. In such embodiments, the media device 102 (a fixed electronic device) and the one or more authorizing mobile electronic devices 106 (mobile electronic devices) include a Bluetooth transceiver. The detectable range of the wireless signal 104 by the media device 102 is inherently limited to several meters by the Bluetooth technology.

The Bluetooth protocol provides for secure exchange of information between a master device (here, the authorizing mobile electronic device 106) and one or more slave devices (here, the media device 102). Under the Bluetooth protocol, the master device (the authorizing mobile electronic device 106) periodically broadcasts our the wireless signal 104 having its identifier of the broadcasting Bluetooth device therein. In the various embodiments of the media device security system 100, the media device 102 only needs to detect the emitted wireless signal 104 from the Bluetooth compatible authorizing mobile electronic device 106. The media device 102 is not required to emit a return signal to the emitting authorizing mobile electronic device 106, unless otherwise required by the particular wireless protocol in use.

Alternatively, or additionally, embodiments may be configured to receive wireless signal 104 using a wireless local area network (LAN) protocol such as under the Institute of Electrical and Electronics Engineers (IEEE) 802.11 standard or other similar standard. For example, the authorizing mobile electronic device 106c may be a user's portable laptop computer, notebook, or the like that is configured to communicate wirelessly with a non-mobile electronic device such as a printer or to websites via the Internet. Embodiments of the authorizing mobile electronic device 106c may be configured to communicate using a wireless LAN protocol. Other embodiments may employ a Wi-Fi compatible protocol.

In embodiments that are configured to detect wireless signals emitted from a portable laptop computer, notebook, or the like, the user must be actively operating the device such that the device is emitting a detectable wireless signal, such as to a printer, a network connection hub, a Wi-Fi device, or other wireless device. The media device 102 can then detect these wireless communications between the authorizing mobile electronic device 106c and the other wireless device. Some cell phones, smart phones and/or note pads may not be provisioned with a Bluetooth system. These devices may be an authorizing mobile electronic device 106c when operated as described above. In some embodiments, such devices may be configured to not use their Bluetooth system to emit a wireless signal that is used for authorizing the media device 102. Rather, such devices may be configures to emit wireless signals as described above which are then used to authorize the media device 102.

In some embodiments, a pop up window may be presented on a display of, or coupled to, the authorizing mobile electronic device 106c. The pop up may indicate that a user selection should be made via the pop up presented by the authorizing mobile electronic device 106c (or by the cell phones, smart phones and/or note pads). In response to the selection, a suitable wireless signal 104 may be emitted to authorize the mobile device 102.

Alternatively, or additionally, embodiments of the media device security system 100 may be configured to detect a wireless signal 104 emitted by a key fob 106d is a security device that is configured to control at least one function another electronic-based device, such as a door lock, an automobile, or other vehicle. Control instructions are communicated from the key fob 106d using a wireless signal. In the various embodiments, an identifier in the wireless signal 104 emitted by the key fob 106d is used to identify the emitting key fob as an authorizing mobile electronic device 106. The wireless signal 104 is emitted in response to the user's actuation of one or more of the controllers disposed on the surface of the key fob 106d. Alternatively, the key fob 106d may be used only for authorization at the media device 102.

In an example embodiment wherein the media device is configured to recognize the key fob 106d as being an authorizing mobile electronic device 106, the user simply actuates one or more of the designated controllers on the key fob 106d. For example, if the key fob 106d is for an automobile, the user's actuation of the “lock door” controller (which causes the key fob 106d to emit a special communication signal that causes the controlled automobile to lock its doors) causes the key fob 106d to emit a wireless signal that is recognized as an authorizing wireless signal 104. It is appreciated that the “lock door” signal includes an identifier of the key fob 106d so that the particular controlled automobile responds (and so that other automobiles do not respond). Thus, the identifier in the wireless signals emitted by the key fob 106d may be used for authorization of the media device 102.

Since the key fob 106d does not continuously emit wireless signals, embodiments of the media device security system 100 require that the user indicate that they are leaving the operating environment 108. Accordingly, the user simply actuates one or more of the designated controllers on the key fob 106d as they are leaving the operating environment 108. A further advantage in this particular situation is that the user may choose to “lock” the media device 102 by actuation of the key fob 106d, thereby prohibiting access to otherwise restricted content and/or performance of otherwise restricted functions even while they are present in the operating environment 108.

In an example embodiments, any wireless signal emitted by the key fob 106d may be used to authorize, and then de-authorize (i.e., end authorization), the media device 102. In other embodiments, a predefined first one of the controllers on the key fob 106d (such as an “unlock door” controller) may be used to authorize the media device 102 and a predefined second different one of the controllers (such as the “lock door” controller) may be used to de-authorize the media device.

Other types of wireless signal mediums may be used by embodiments of the media device security system 100. For example, some electronic devices employ a line of sight signal, such as an infra red signal. If such electronic devices include an identifier in its emitted infra red signal, then such devices may be identified by the media device 102 as an authorizing mobile electronic device 106.

In the various embodiments, the various alternative wireless communication protocols work best if they are configured to communicate using a limited range and/or strength wireless signal 104. However, some wireless protocols communicate with a wireless signal 104 that has a range that extends beyond the limited dimensions of the operating environment 108. Accordingly, some embodiments may use a predefined signal strength threshold that corresponds to a signal strength of the emitted wireless signal 104 as measured at a predefined (and relatively short) distance from the emitting electronic device 106.

One skilled in the art appreciates the attenuation of a wireless signal as it propagates through a medium, such as air. For any particular electronic device 106, the initial output signal strength of the emitted wireless signal 104 is known or is determinable. For example, the initial output signal strength of the emitted wireless signal 104 may be known from device specifications and/or from information provided by the device manufacturer. The signal strength and/or other characteristics of the emitted wireless signal 104 may then be used to compute the expected signal strength when the mobile electronic device 106 is located at the maximum extents of the dimensions of the operating environment 108 based on the known attenuation properties of air and/or other characteristics of the operating environment 108). The expected signal strength may then be saved by the media device 102 as a predefined reference signal strength.

Alternatively, or additionally, the media device 102 may be configured to detect the emitted wireless signal 104 when the emitting electronic device 106 is in the immediate vicinity of the media device 102. The signal strength and/or other characteristics of the emitted wireless signal 104 may then be used to compute the expected signal strength when the mobile electronic device 106 is located at the maximum extents of the dimensions of the operating environment 108 based on the known attenuation properties of air and/or other characteristics of the operating environment 108). The expected signal strength may then be saved by the media device 102 as the predefined reference signal strength.

Alternatively, or additionally, a wireless signal 104 may be emitted when the mobile electronic device 106 is located at the maximum extents of the dimensions of the operating environment 108. The detected signal strength may then be saved as the predefined reference signal strength by the media device 102.

During operation, if the media device detects the wireless signal 104 having a signal strength that is at least equal to, or that exceeds, the predefined reference signal strength, the media device determines that the emitting electronic device 106 is located within the operating environment 108 (thereby authorizing access to otherwise restricted content and/or performance of otherwise restricted functions). If the media device detects the wireless signal 104 having a signal strength that is less than the predefined reference signal strength, the media device determines that the emitting electronic device 106 is not located within the operating environment 108 (thereby prohibiting or limiting access to otherwise restricted content and/or performance of otherwise restricted functions).

Here, the signal strength of the received wireless signal 104 is compared with the signal strength value of the predefined reference signal (a reference signal strength threshold). If the signal strength of the detected wireless signal 104 is equal to or greater than the predefined reference signal strength threshold, then embodiments of the media device security system 100 determine that the emitting electronic device 106 is within the extents of the operating environment 108. Therefore, embodiments infer that the user is present in the operating environment 108 (and thereby permitting access to otherwise restricted content and/or performance of otherwise restricted functions by the media device 102).

The example media device 102 is illustrated in FIG. 1 as a set top box (STB). The exemplary media device 102 is communicatively coupled to components of a media presentation system 116 that includes a visual display device 118, such as a television (hereafter, generically a TV), and an audio presentation device 120, such as a surround sound receiver controlling an audio reproduction device (hereafter, generically, a speaker). Other types of output devices may also be coupled to the media device 102, including those providing any sort of stimuli sensible by a human being, such as temperature, vibration and the like. The video portion of the media content event is displayed on the display 122 and the audio portion of the media content event is reproduced as sounds by one or more speakers 124. In some embodiments, the media device 102 and one or more of the components of the media presentation system 116 may be integrated into a single electronic device.

The non-limiting exemplary media device 102 comprises a media content stream interface 126, a processor system 128, a memory 130, a program buffer 132, an optional digital video recorder (DVR) 134, a presentation device interface 136, a remote interface 138, an optional wireless signal detector 140, and an optional interne interface 142. The memory 130 comprises portions for storing the media device logic 144, the optional browser 146, the electronic program guide (EPG) information 148, the security processing logic 150, a list of the authorizing devices 152, and a list of the restricted content and functions 154. In some embodiments, the optional wireless signal detector 140 may be a transceiver configured to communicate and receive information. In some embodiments, the media device logic 144 and the security processing logic 150 may be integrated together, and/or may be integrated with other logic. In other embodiments, some or all of these memory and other data manipulation functions may be provided by and using remote server or other electronic devices suitably connected via the Internet or otherwise to a client device. Other media devices 102 may include some, or may omit some, of the above-described media processing components. Further, additional components not described herein may be included in alternative embodiments.

The functionality of the media device 102, here a set top box, is now broadly described. A media content provider provides media content that is received in one or more multiple media content streams 156 multiplexed together in one or more transport channels. The transport channels with the media content streams 156 are communicated to the media device 102 from a media system sourced from a remote head end facility (not shown) operated by the media content provider. Non-limiting examples of such media systems include satellite systems, cable system, and the Internet. For example, if the media content provider provides programming via a satellite-based communication system, the media device 102 is configured to receive one or more broadcasted satellite signals detected by an antenna (not shown). Alternatively, or additionally, the media content stream 156 can be received from one or more different sources, such as, but not limited to, a cable system, a radio frequency (RF) communication system, or the Internet.

The one or more media content streams 156 are received by the media content stream interface 126. One or more tuners 126a in the media content stream interface 126 selectively tune to one of the media content streams 156 in accordance with instructions received from the processor system 128. The processor system 128, executing the media device logic 144 and based upon a request for a media content event of interest specified by a user, parses out media content associated with the media content event of interest. The media content event of interest is then assembled into a stream of video and/or audio information which may be stored by the program buffer 132 such that the media content can be streamed out to components of the media presentation system 116, such as the visual display device 118 and/or the audio presentation device 120, via the presentation device interface 136. Alternatively, or additionally, the parsed out media content may be saved into the DVR 134 for later presentation. The DVR 134 may be directly provided in, locally connected to, or remotely connected to, the media device 102. In alternative embodiments, the media content streams 156 may stored for later decompression, processing and/or decryption. In some embodiments, the presentation device interface 136 is an internal component that provides the content to a display 122 that is also a component of the media device 102.

From time to time, information populating the EPG information 148 portion of the memory 130 is communicated to the media device 102, via the media content stream 156 or via another suitable media. The EPG information 148 portion of the memory 130 stores the information pertaining to the scheduled programming. The information may include, but is not limited to, a scheduled presentation start and/or end time, a program channel, and descriptive information. The program's descriptive information may include the title of the program, names of performers or actors, date of creation, and a summary describing the nature of the program which may include a parental rating (e.g., “PG” for parental guidance suggested age audiences, “M” or “MA” for mature age audiences, “R” for restricted age audiences, and/or “X” for adult age audiences). Any suitable information may be included in the program's supplemental information. Upon receipt of a command from the user requesting presentation of an EPG display, the information in the EPG information 148 is retrieved, formatted, and then presented on the display 122 as an EPG.

Some embodiments include the interne interface 142 to provide connectivity to the Internet. For example, a media content event and/or a game may be accessed and retrieved from a remote Internet website. The media content and/or game content may be presented on the display 122 and/or saved for later presentation in the DVR 134 and/or memory 130.

The exemplary media device 102 is configured to receive commands from a user via a remote control 158. The remote control 158 includes one or more controllers 160. The user, by actuating one or more of the controllers 160, causes the remote control 158 to generate and transmit commands, via a wireless signal 162, to the media device 102. The commands control the media device 102 and/or control components of the media presentation system 116. The wireless signal 162 may be an infrared (IR) signal or a radio frequency (RF) signal that is detectable by the remote interface 138.

The processes performed by the media device 102 relating to the processing of the received media content stream 156 and communication of a presentable media content event and/or a game to the components of the media presentation system 116 are generally implemented by the processor system 128 while executing the media device logic 144. Thus, the media device 102 may perform a variety of functions related to the processing and presentation of one or more media content events and/or games.

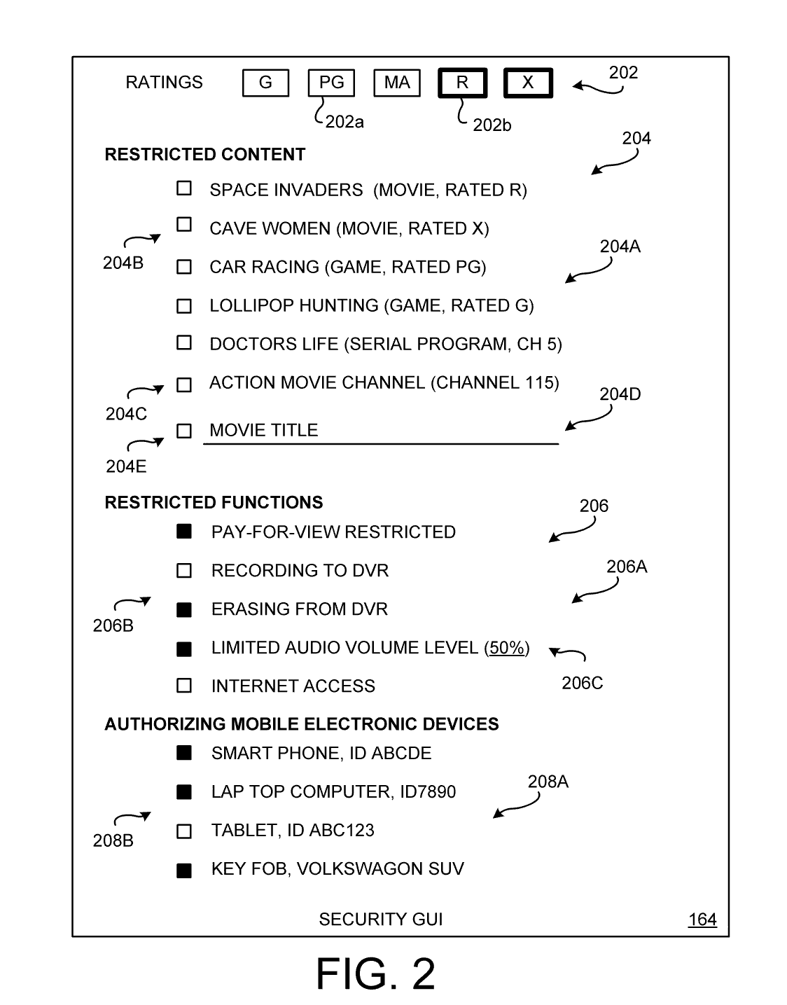

FIG. 2 illustrates an example security GUI 164 that may be displayed to the user be embodiments of the media device security system 100. The security GUI 164, also illustrated in FIG. 1, is presented on a display 122 of, or a display 122 coupled to, the media device 102 to the user during a set-up process. Any suitable format may be used for the security GUI 164.

The presented security GUI 164 may have one or more selection areas that identify particular content and/or functions that can be restricted by the media device 102. In response to selection of a particular selectable item of content and/or a particular function by the user, information that identifies the selected content and/or function is then stored into the list of the authorizing devices 152 such that that selected content and/or function then becomes restricted.

In practice, the security processing logic 150 manages authorized use of the media device 102. The list of the restricted content and functions 154 stores a list of content and/or functions (interchangeably referred to as operations) that may be restricted. The media device 102 may be configured to permit the user to selectively initiate a set up process using the security GUI 164 so that content and/or functions in the list of the restricted content and functions 154 may be added, modified, or deleted. In some embodiments, a particular controller 160 of the remote control 158 may be configured to initiate the set up process by causing presentation of the security GUI 164. Alternatively, or additionally, a menu-based GUI system may be provided so that the user may initiate the set up process so that the security GUI 164 becomes presented.

In the various embodiments, a user identity verification such as a password or the like may be required to initiate presentation of, and/or make changes to, the security GUI 164 so that modifications to the items in the list of the restricted content and functions 154. For example, a new authorizing mobile electronic device 106 and/or removal of a particular authorizing mobile electronic device 106, may require user identity verification at the mobile electronic device 106 and/or at the media device 102. If user identity verification at the authorizing mobile electronic device 106 is required, a suitable GUI or the like may be presented on a display of the authorizing mobile electronic device 106, and may even require a user response and/or a password or the like. Alternatively, or additionally, a second user identity verification may be required at the media device 102, such as specification of a password of the like using the remote control 158. Alternatively, or additionally, presence of at least one of the authorizing mobile electronic devices 106 may be required to initiate presentation of, and/or to make changes to, the security GUI 164.

With respect to restricted content, one or more particular ratings (PG, M, MA, R, X, or the like) may be stored as a reference parental guidance rating in the list of the restricted content and functions 154. In the example security GUI 164 of FIG. 2, the rating boxes “R” and “X” are indicated as being currently restricted (as indicated by the dark bold line around those ratings) in the example selection area 202. Any suitable shading, color, font, and/or line thickness may be used to indicate selected and non-selected features. In the simplified example of FIG. 2, if the user selects the “PG” rating selection box 202a, then the “PG” rating is then used to restrict future access to content having that rating. If the user selects the “R” rating selection box 202b, content associated with an “R” rating will no longer be restricted.

The media device 102 is configured to prohibit presentation of content, such as a movie, when the parental guidance rating of the movie matches the at least one reference parental guidance rating stored in the memory. Alternatively, the media device 102 permits presentation of the content when the parental guidance rating for the content is different from the at least one reference parental guidance rating stored in the memory. In an example embodiment, the parental guidance rating for the content is found in the EPG information 148 stored in memory.

If access is attempted to a media content event or a game that has a rating that corresponds to a restricted rating, then access to that particular media content event would be prohibited if the media device 102 has not been authorized (i.e., has not detected, or is not detecting, the wireless signal 104 being emitted by one or more authorizing mobile electronic devices 106). If the parental guidance rating of the requested content or game does not match one of the restricted parental guidance ratings, then presentation may begin. Ratings for media content events may be included in the metadata of the accessed media content event and/or may be included as information stored in the EPG information 148.

Alternatively, or additionally, a particular identifier associated with the accessed content may be stored in the list of the restricted content and functions 154. For example, the selection area 204 of the security GUI 164 illustrates a plurality of titles 204a of particular media content events, serial programs, games, or the like may be stored in the list of the restricted content and functions 154. If content with that particular associated identifier is accessed, then access is denied unless the media device 102 is authorized.

To de-select one of the listed content times, the user may select one of the selection boxes 204b. As an example, access to a particular channel of media content may be prohibited by storing the channel number or other suitable channel identifier in the list of the restricted content and functions 154. Here, if the user selects the selection box 204c next to the listed channel “Action Movie Channel” (corresponding to a name of a restricted channel of content), then this particular channel becomes un-restricted and may be later accessed by any user of the media device 102. The title or identifier of the channel may then optionally be deleted from the security GUI 164 when the security GUI 164 is refreshed or is later presented. Alternatively, a de-selected title or identifier of the channel may remain shown on a refreshed or later presented security GUI 164 so that the user may be reminded that that particular content had been previously restricted.

A selection area 204d is provided so that new content items may be specified for restriction. For example, the user may manually enter a movie title and/or other keywords of interest, which then becomes restricted. For example, if “Friday the 13^{th}” is entered as user defined keywords, some scary movies having that keyword phrase in its title and/or in its metadata may be then restricted. Alternatively, or additionally, if the user selects the adjacent selection box 204e, then an EPG is presented on the display 122. Then, selection of one or more programs from the EPG, or even an entire channel, results in the EPG selected items becoming added to the list of the restricted content and functions 154.

Particular functions may also be restricted if the media device 102 is not currently authorized. The example security GUI 164 presents a region 206 for selection of functions that are to be restricted. Titles describing example restricted functions are shown in the area 206a.

Selection boxes 206b are shown adjacent to each listed function to indicate whether the listed adjacent function is currently restricted or is currently unrestricted. Any suitable means or demarking selection boxes 206b to indicate whether a particular listed function is restricted or unrestricted. In FIG. 2, black shading is used to indicate a restriction. No shading or white shading is used to indicate no currently enforced restriction. Alternative embodiments only list the identifiers of restricted functions.

In the simplified example illustrated in FIG. 2, the functions associated with purchasing pay-for-view media content, erasing content from the DVR 134, and limiting audio volume of presented content are indicated as being currently restricted. Thus, an unauthorized user (determined by absence of a wireless signal 104 being issued from one or more authorizing mobile electronic devices 106) cannot erase content from the DVR 134, access pay-for view-content, or increase audio volume above 50% of maximum audio volume. In some embodiments, the limiting level of the audio volume may be adjustable by an authorized user. For example, the user may select the region 206c using their remote control 158, and then use arrow controllers or other controllers 160 to change, increase or decrease the maximum volume limit.

Further, FIG. 2 illustrates that the functions of recording content to the DVR 134 and accessing the Internet using the media device 102 are not currently restricted. If the user selects one of the adjacent selection boxes 206b, then the restrictions status is changed. For example, if the user selects the selection box adjacent to the “Internet Access” function, then future access to the Internet becomes restricted. If the user selects the selection box adjacent to the “Pay-for-View” functions, then the function become un-restricted and later access to pay-for-view content by any user is permitted by the media device 102.

In some embodiments, purchasing other goods or services using the media device 102 by restricted by simply storing that particular function in the list of the restricted content and functions 154. Alternatively, or additionally, specific websites may be identified in the list of the restricted content and functions 154 so as to prohibit the purchasing. For example, but not limited to, a website “Shopping Network” may be identified in the list of the restricted content and functions 154 so that items cannot be purchased at that website when the media device 102 is not currently authorized (even though purchases at other non-listed websites may be permitted).

Many different types of mobile electronic devices may be operable to emit wireless signals that may be detectable by the media device 102. A listing of authorizing mobile electronic devices 106 is stored in the list of the authorizing devices 152 residing in memory 130. The identifier or each authorizing mobile electronic device 106 is used to compare with the identifier in a received wireless signal 104. If the identifiers match, then authorization of otherwise restricted content and/or functions by the media device 102 is permitted. Accordingly, one or more mobile devices may be defined as an authorizing mobile electronic device 106. Additionally, other information associated with each authorizing mobile electronic device 106 may be included in the list of the restricted content and functions 154.

The security GUI 164 also indicates the currently authorized mobile electronic devices 106. For example, but not limited to, a textual descriptor 208a each the authorizing mobile electronic device 106 may stored in the list of the authorizing devices 152 for presentation on the security GUI 164. A unique identifier may also be stored and/or presented. Selection boxes 208b may be used to indicate current status of detectable mobile devices. Here, the smart phone (with identifier “ABCDE”), the lap top computer (with identifier “ID7890”) and the key fob (that controls the Volkswagen SUV automobile) are indicated as being currently authorized mobile electronic devices 106. Accordingly, if the wireless signal detector 140 of the media device 102 detects an emitted wireless signal 104 from any one of these devices, the media device will be able to access otherwise restricted content and/or perform otherwise restricted functions. Alternatively, or additionally, any suitable shading, coloring, and/or highlighting may be sued to indicate particular authorizing mobile electronic devices 106 that are currently being detected at the media device 102.

It is appreciated that the communication formats used to emit wireless signals by different mobile electronic devices 106 may be different from each other. Accordingly, a plurality of different wireless signal detectors 140 each configured to detect different communication mediums may be included in the media device 102. Alternatively, or additionally, the wireless signal detector 140 may be configured to detect signals emitted under different signal formats and/or mediums. For example, the wireless signal detector 140 may be configured to detect a wide frequency range of radio signals.

In some embodiments, the wireless signal detector 140 may be omitted if the remote interface 138 is also configured to detect a wireless signal 104 that is emitted by at least one authorizing mobile electronic device 106.

The simplified security GUI 164 illustrated in FIG. 2 further indicates that the tablet computer (with identifier “ABC123”) is not currently an authorizing mobile electronic device 106. Accordingly, if the media device detects a wireless signal emitted by that tablet, access to otherwise restricted content and/or performance of otherwise restricted functions is not permitted. However, if the user selects the adjacent selection box 206b, then the tablet type computer will then become an authorizing mobile electronic device 106. Here, the identifier of that tablet becomes stored in the list of the authorizing devices 152.

Similarly, if the user selects the selection box adjacent to the key fob, then that particular key fob is no longer recognized as an authorizing mobile electronic device 106. Here, the identifier associated with the key fob may be removed from the list of the authorizing devices 152, and/or may be flagged as becoming an unauthorized mobile device.

During the set up process using the security GUI 164, a new mobile device may be designated as an authorizing mobile electronic device 106. In an example embodiment, the user may enter the identity of the mobile electronic device 106 that is to become authorized. In some embodiments, the identity of the mobile electronic device 106 may be specified at a website or other remote location to further reduce the possibility of tampering by an unauthorized user. Further, an authorized service person may be the only individual who may enter the identity of the mobile electronic device 106. The media device 102, using the browser 146, may access from a remote website signal a specification and/or an identifier associated with wireless signals emitted by the newly designated mobile electronic device 106. Then, at a later time, the wireless signal 104 from the newly designated mobile electronic device 106 will be recognized such that access to otherwise restricted content and/or performance of otherwise restricted functions is permitted. In some embodiments, a master authorizing mobile electronic device 106 must be present before a newly designated mobile electronic device 106 becomes recognized as an authorizing mobile electronic device 106.

Alternatively, or additionally, the user may bring the mobile device that is to become authorized into close proximity to the media device 102. The media device 102 may then detect wireless signals emitted by that particular mobile device. Information identifying that particular emitted wireless signal may then be saved into the list of the authorizing devices 152 so that the detected mobile device now become one of the authorizing mobile electronic devices 106.

During the above-described process of initially detecting a signal emitted by a mobile device, the signal strength of the emitted wireless signal may be determined and then saved. Then, based on attenuation characteristics of the operating environment 108, a reduced value of signal strength may be determined. The value is then saved as the predefined reference signal strength threshold. If a wireless signal 104 has a strength that corresponds to the reference signal strength threshold, the newly identified mobile electronic device 106 is determined to be within the extents of the operating environment 108. If the strength of the wireless signal 104 emitted by that particular mobile electronic device 106 is less than the predefined reference signal strength threshold, then the media device is determined to be outside of the extents of the operating environment 108 and the media device 102 will not be authorized.

In some embodiments, an authorized installer is present during initial installation of the media device 102. The installer, during the initial set installation of the media device 102, may configure the media device to recognize one or more mobile electronic devices as being authorizing mobile electronic devices 106.

A particular authorizing mobile electronic device 106 may be configured for selected access to otherwise restricted content and/or performance of otherwise restricted functions. For example, the mobile electronic devices 106 of the parents of a household may be configured to provide access to all otherwise restricted content and/or performance of otherwise restricted functions. In contrast, the mobile electronic device 106 of an older teen may permit access to “PG” or “MA” content while preventing access to “R” and “X” rated content. In such embodiments, the security GUI 164 may be further configured to indicate which particular restricted content and/or performance of otherwise restricted functions will be enabled for each particular ones of the authorizing mobile electronic devices 106.

Some embodiments may be configured to cooperatively provide media device security with other security systems implemented in the media device 102. For example, the user may be required to enter user identity verification such as a security code, personal identification number (PIN), password or the like by a security system. An example embodiment of the media device security system 100 may also require presence of at least one authorizing mobile electronic device 106, in addition to user entry of the user identity verification. The requirement of multiple security inputs (the input security code, personal identification number, password or the like, in conjunction with concurrent detection of a wireless signal 104 being emitted by a authorizing mobile electronic device 106) may be required for all listed content and/or functions that is to be otherwise restricted, or may be limited to selected content and/or functions. For example, an application on a mobile electronic device 106 may be required to enable access. As another nonlimiting example, parents of a household may require the additional password in conjunction with the presence of their particular authorizing mobile electronic device 106 before access to “X” rated content is permitted.

Some embodiments may be configured to permit access to otherwise restricted content and/or performance of otherwise restricted functions in the absence of one or more authorizing mobile electronic devices 106 if another security system is properly authorized by a user. For example, a user identity verification, such as a correct security code, personal identification number, password or the like, may be provided by an authorized user. Then, access to otherwise restricted content and/or performance of otherwise restricted functions may be enabled.

In some embodiments, if an attempted access to otherwise restricted content and/or performance of otherwise restricted functions is detected by the media device 102, and no wireless signal 104 is detected, the media device 102 may present a verification pop up on the display 122. The verification pop up indicates that the requested access to otherwise restricted content and/or performance of otherwise restricted functions is currently denied, and may then request that the user bring at least one authorizing mobile device 106 into proximity of the media device 102, and/or operate at least one authorizing mobile electronic device 106, so that access may then be permitted. For example, the verification pop up may indicate that access will be granted after the user actuates one of the controllers on their key fob 106d. Here, the wireless signal 104 emitted by the key fob 106d would be detected.

As another example, a telephone base station may include a Bluetooth transceiver 114. When a incoming call is received, a caller identification (ID) function may determine the incoming call number. The media device may detect the emitted Bluetooth signal with the caller ID number therein. If the caller ID number is saved in the list of the authorizing devices 152, then access to otherwise restricted content and/or performance of otherwise restricted functions may be permitted. Here, the user may simply use their mobile phone or smart phone to call the telephone base station. Upon receipt of the incoming call with the caller ID of the authorized user, access to otherwise restricted content and/or performance of otherwise restricted functions is then permitted.

It should be emphasized that the above-described embodiments of the media device security system 100 are merely possible examples of implementations of the invention. Many variations and modifications may be made to the above-described embodiments. All such modifications and variations are intended to be included herein within the scope of this disclosure and protected by the following claims.

1. A media device, comprising:
a wireless signal detector configured to a detect a wireless signal emitted by at least one mobile electronic device that is currently in possession of a user, wherein the detected wireless signal includes information corresponding to at least an identifier of the at least one mobile electronic device;
a means for receiving content configured to receive content;
a presentation device interface configured to communicate the content to a display for presentation to the user;
a memory, wherein the memory is configured to:
store a plurality of mobile device identifiers, wherein each stored mobile device identifier is configured to identify one of a plurality of mobile electronic devices,
store a listing of restricted content that identifies restricted content, and
store a listing of restricted functions that identifies restricted functions;
a processor system communicatively coupled to the wireless signal detector, the presentation device interface, and the memory, wherein the processor system is configured to:
determine the identifier of the at least one mobile electronic device from the information in the detected wireless signal;
compare the identifier of the at least one mobile electronic device with the plurality of stored mobile device identifiers;
determine a signal strength of the detected wireless signal emitted by the at least one mobile electronic device;
compare the determined signal strength with a predefined reference signal strength threshold stored in the memory;
permit the media device to access the restricted content only when the identifier of the at least one mobile electronic device matches one of the plurality of stored mobile device identifiers and when the determined signal strength is at least equal to the predefined reference signal strength threshold; and
permit the media device to perform the restricted functions only when the identifier of the at least one mobile electronic device matches one of the plurality of stored mobile device identifiers and when the determined signal strength is at least equal to the predefined reference signal strength threshold.

2. The media device of claim 1, wherein the processor system is further configured to:
prohibit the media device from accessing the restricted content when the identifier of the at least one mobile electronic device does not match one of the plurality of stored mobile device identifiers; and
prohibit the media device from performing the restricted functions when the identifier of the at least one mobile electronic device does not match one of the plurality of stored mobile device identifiers.

3. The media device of claim 1, wherein the wireless signal emitted by the at least one mobile electronic device is configured to control operation of another electronic-based device that performs at least one other function that is unrelated to control of at least one of the media device and a component of a media presentation system.

4. The media device of claim 1, wherein the means for receiving the content comprises at least one selected from a group consisting of:
a media content stream interface configured to receive a media content stream that includes the content;
a digital video recorder (DVR) configured to receive the content; and
an internet interface configured to communicatively couple the media device to the Internet and configured to receive the content from a remote website.

5. The media device of claim 1,
wherein the content is at least one of a movie and a game,
wherein, in response to a user request for presentation of content, the processor system is further configured to:
access a parental guidance rating of at least one movie and game;
compare the parental guidance rating of the at least one movie and game with at least one reference parental guidance rating;
permit presentation of the at least one movie and game by the media device when the parental guidance rating of the at least one movie and game matches the at least one reference parental guidance rating and when the identifier of the at least one mobile electronic device matches one of the plurality of stored mobile device identifiers;
prohibit presentation of the at least one movie and game by the media device when the parental guidance rating of the at least one movie and game matches the at least one reference parental guidance rating and when the identifier of the at least one mobile electronic device does not match one of the plurality of stored mobile device identifiers; and
permit presentation of the at least one movie and game by the media device when the parental guidance rating of the at least one movie and game is different from the at least one reference parental guidance rating.

6. The media device of claim 5,
wherein the means for receiving receives electronic program guide (EPG) information,
wherein the received EPG information is stored in the memory,
wherein the processor system is further configured to:
access the parental guidance rating of the movie from the stored EPG information;
compare the parental guidance rating of the movie with the at least one reference parental guidance rating stored in the memory;
permit presentation of the movie by the media device when the parental guidance rating of the movie matches the at least one reference parental guidance rating and when the identifier of the at least one mobile electronic device matches one of the plurality of stored mobile device identifiers;
prohibit presentation of the movie by the media device when the parental guidance rating of the movie matches the at least one reference parental guidance rating and when the identifier of the at least one mobile electronic device does not match one of the plurality of stored mobile device identifiers; and
permit presentation of the movie by the media device when the parental guidance rating of the movie is different from the at least one reference parental guidance rating.

7. The media device of claim 5,
wherein the parental guidance rating for the at least one movie and game resides in metadata of the at least one movie and game,
wherein the processor system is further configured to:
access the parental guidance rating of the at least one movie and game from the metadata;
compare the parental guidance rating of the at least one movie and game with at least one reference parental guidance rating stored in the memory;
permit presentation of the at least one movie and game by the media device when the parental guidance rating of the at least one movie and game matches the at least one reference parental guidance rating and when the identifier of the at least one mobile electronic device matches one of the plurality of stored mobile device identifiers;
prohibit presentation of the at least one movie and game by the media device when the parental guidance rating of the at least one movie and game matches the at least one reference parental guidance rating and when the identifier of the at least one mobile electronic device does not match one of the plurality of stored mobile device identifiers; and
permit presentation of the at least one movie and game by the media device when the parental guidance rating of the movie is different from the at least one reference parental guidance rating.

8. The media device of claim 1,
a remote interface configured to receive wireless signals from a remote control,
wherein the received wireless signal defines at least one command configured to control a function of the media device,
wherein the processor system permits the media device to perform the restricted function when the identifier of the at least one mobile electronic device matches one of the plurality of stored mobile device identifiers, and
wherein the processor system prohibits the media device from performing the restricted function when the identifier of the at least one mobile electronic device does not match one of the plurality of stored mobile device identifiers.

9. A media device, comprising:
a wireless signal detector configured to a detect a wireless signal emitted by at least one mobile electronic device that is currently in possession of a user, wherein the detected wireless signal includes information corresponding to at least an identifier of the at least one mobile electronic device;
a means for receiving content configured to receive content;
a presentation device interface configured to communicate the content to a display for presentation to the user;
a memory, wherein the memory is configured to:
store a plurality of mobile device identifiers, wherein each stored mobile device identifier is configured to identify one of a plurality of mobile electronic devices,
store a listing of restricted content that identifies restricted content, and
store a listing of restricted functions that identifies restricted functions;
a processor system communicatively coupled to the wireless signal detector, the presentation device interface, and the memory, wherein the processor system is configured to:
determine the identifier of the at least one mobile electronic device from the information in the detected wireless signal;
compare the identifier of the at least one mobile electronic device with the plurality of stored mobile device identifiers;
permit the media device to access the restricted content only when the identifier of the at least one mobile electronic device matches one of the plurality of stored mobile device identifiers;
permit the media device to perform the restricted functions only when the identifier of the at least one mobile electronic device matches one of the plurality of stored mobile device identifiers;
a digital video recorder (DVR) configured to record content received by the media device; and
a remote interface configured to receive wireless signals from a remote control, wherein the received wireless signal defines at least one command configured to control a function of the media device,
wherein the command is at least one of a command to store content into the DVR and a command to delete content from the DVR,
wherein the processor system permits the media device to record the content or erase the content when the identifier of the at least one mobile electronic device matches one of the plurality of stored mobile device identifiers, and
wherein the processor system prohibits the media device from recording the content or erasing the content when the identifier of the at least one mobile electronic device does not match one of the plurality of stored mobile device identifiers.

10. The media device of claim 8,
wherein the means for receiving the content is an interne interface configured to communicatively couple the media device to the Internet and configured to receive the content from a remote web site,
wherein the command is a command to access the web site,
wherein the processor system permits the media device to access the remote website when the identifier of the at least one mobile electronic device matches one of the plurality of stored mobile device identifiers, and
wherein the processor system prohibits the media device from accessing the remote website when the identifier of the at least one mobile electronic device does not match one of the plurality of stored mobile device identifiers.

11. The media device of claim 8,
wherein the means for receiving the content is a media content stream interface configured to receive a media content stream that includes the content,
wherein the command is a command to access a specified channel of content residing in the received media content stream,
wherein the processor system permits the media device to access the specified channel of content when the identifier of the at least one mobile electronic device matches one of the plurality of stored mobile device identifiers, and
wherein the processor system prohibits the media device from accessing the specified channel of content when the identifier of the at least one mobile electronic device does not match one of the plurality of stored mobile device identifiers.

12. The media device of claim 1, wherein the at least one mobile electronic device is a cell phone that is configured to communicate at least voice communications with other telephonic devices.

13. The media device of claim 1, wherein the at least one mobile electronic device is a key fob that is configured to control at least one function of a vehicle.

14. The media device of claim 1, wherein the at least one mobile electronic device is a tablet computer that is configured to communicate wirelessly with at least one non-mobile electronic device.

15. The media device of claim 1, wherein the processor system is further configured to:
prohibit the media device from accessing the restricted content or from performing the restricted functions when the determined signal strength is less than the predefined reference signal strength threshold.

16. The media device of claim 1, wherein the processor system is further configured to:
receive a user specification of a user identity verification;
compare the received user identity verification with a predefined user identity verification;
permit the media device to access the restricted content only when the identifier of the at least one mobile electronic device matches one of the plurality of stored mobile device identifiers and when the received user identity verification matches the predefined user identity verification;
permit the media device to perform the restricted functions only when the identifier of the at least one mobile electronic device matches one of the plurality of stored mobile device identifiers and when the received user identity verification matches the predefined user identity verification; and
prohibit the media device from accessing the restricted content or from performing the restricted functions when the received user identity verification is different from the predefined user identity verification.

17. A method, comprising:
detecting, at a media device, a wireless signal emitted by at least one mobile electronic device that is currently in possession of a user, wherein the detected wireless signal includes information corresponding to at least an identifier of the at least one mobile electronic device;
determining, at the media device, the identifier of the at least one mobile electronic device from the information in the detected wireless signal;
retrieving, from a memory of the media device, a plurality of stored mobile device identifiers, wherein each stored mobile device identifier identifies one of a plurality of mobile electronic devices;
comparing the identifier of the at least one mobile electronic device with the plurality of stored mobile device identifiers;
determining a signal strength of the detected wireless signal emitted by the at least one mobile electronic device;
comparing the determined signal strength with a predefined reference signal strength threshold stored in the memory;
permitting the media device to access restricted content only when the identifier of the at least one mobile electronic device matches one of the plurality of stored mobile device identifiers and when the determined signal strength is at least equal to the predefined reference signal strength threshold; and
permitting the media device to perform a restricted function only when the identifier of the at least one mobile electronic device matches one of the plurality of stored mobile device identifiers and when the determined signal strength is at least equal to the predefined reference signal strength threshold.

18. The method of claim 17, further comprising:
prohibiting access by the media device to the restricted content when the identifier of the at least one mobile electronic device does not match any of the plurality of stored mobile device identifiers; and
prohibiting performance by the media device of the restricted function when the identifier of the at least one mobile electronic device does not match any of the plurality of stored mobile device identifiers.

19. The method of claim 17, wherein the wireless signal emitted by the at least one mobile electronic device is configured control operation of another electronic-based device that performs at least one other function that is unrelated to control of at least one of the media device and a component of a media presentation system that is controlled by the media device.

20. The method of claim 17, wherein the content is at least one of a movie and a game, and wherein, in response to a user request for presentation of content, the method further comprises:
accessing a parental guidance rating of at least one movie and game;
comparing the parental guidance rating of the at least one movie and game with at least one reference parental guidance rating stored by the media device;
permitting presentation of the at least one movie and game by the media device when the parental guidance rating of the at least one movie and game matches the at least one reference parental guidance rating and when the identifier of the at least one mobile electronic device matches any of the plurality of stored mobile device identifiers;
prohibiting presentation of the at least one movie and game by the media device when the parental guidance rating of the at least one movie and game matches the at least one reference parental guidance rating and when the identifier of the at least one mobile electronic device does not match any of the plurality of stored mobile device identifiers; and
permitting presentation of the at least one movie and game by the media device when the parental guidance rating of the at least one movie and game is different from the at least one reference parental guidance rating.

21. The media device of claim 1, wherein the reference signal strength threshold is defined by an expected signal strength of the wireless signal emitted by the at least one mobile device when located at a maximum extent of an operating environment of the media device, wherein the processor system is further configured to:
detect a first wireless signal emitted by the emitted by the at least one mobile device when located in the immediate vicinity of the media device;
determine a first signal strength of the detected first wireless signal;
compute the expected signal strength based on the determined first signal strength of the detected first signal and based on known attenuation properties of air or other characteristics of the operating environment; and
store the computed expected signal strength into the memory as the reference signal strength threshold.

22. The media device of claim 1, wherein the reference signal strength threshold is defined by an expected signal strength of the wireless signal emitted by the at least one mobile device when located at a maximum extent of an operating environment of the media device, wherein the processor system is further configured to:
compute the expected signal strength based on an known output signal strength of the wireless signal that is output from the at least one mobile device, and based on known attenuation properties of air or other characteristics of the operating environment; and
store the computed expected signal strength into the memory as the reference signal strength threshold.

23. The media device of claim 1, wherein the reference signal strength threshold is defined by an expected signal strength of the wireless signal emitted by the at least one mobile device when located at a maximum extent of an operating environment of the media device, wherein the processor system is further configured to:
detect a first wireless signal emitted by the emitted by the at least one mobile device when located at the maximum extent of the operating environment;
determine a first signal strength of the detected first wireless signal;
compute the expected signal strength based on the determined first signal strength of the detected first signal and based on known attenuation properties of air or other characteristics of the operating environment; and
store the computed expected signal strength into the memory as the reference signal strength threshold.
